(19) United States
(12) Patent Application Publication
(10) Pub. No.: US 2018/0119994 A1
(43) Pub. Date: May 3, 2018

(54) Floating Solar System

(71) Applicant: Floatorack Corp., Oakland, CA (US)

(72) Inventors: Troy Anthony Helming, Oakland, CA (US); Kenneth Roy Forrest, Sebastopol, CA (US)

(21) Appl. No.: 15/796,689

(22) Filed: Oct. 27, 2017

Related U.S. Application Data
(60) Provisional application No. 62/413,798, filed on Oct. 27, 2016.

(51) Int. Cl. F24J 2/52; H02S 20/32; H02S 30/10; H02S 10/40

(52) U.S. Cl. CPC F24J 2/5267; H02S 10/40; H02S 30/10; H02S 20/32

(57) ABSTRACT

A floating solar system be used on water, utilizes an aluminum support structure, aluminum, HDPE floatation elements which are designed to have minimal solar exposure. The aluminum support structure is designed to absorb all structural torque and other forces.

### RELATED APPLICATION

The present application claims priority to U.S. Provisional Patent Application No. 62/413,798, filed on Oct. 27, 2016 and incorporates that application in its entirety.

### FIELD

The present invention relates to solar power, and more particularly a Floating Solar System on water.

### BACKGROUND

Solar panels are becoming more commonly installed on home roofs and offices. The increased use of solar panels has been removing arable farm land from agricultural use. Additionally, as solar panels get hot, their efficiency is reduced.

One method of addressing these issues is by placing solar panels on water. However, the existing solutions for such solar panels have numerous limitations. The cost is quite high, and the panels and materials degrade relatively quickly. The heat causes cracking, tearing, and rupture over time. Solar power plants also are generally subject to soiling (dust accumulation) which degrades the performance by up to 25-40% without regular panel washing. Additionally, there are issues in securing the solar panel in water, as the water level varies.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is an illustration of an exemplary installation of the floating solar system in a reservoir.

FIG. 2A is an illustration showing one embodiment of a portion of the floating solar system.

FIG. 2B illustrating an overview of elements in the single highlighted block of FIG. 2A.

FIG. 3 is a perspective view of one embodiment of a two panel sub-portion of a block.

FIG. 4 illustrates one embodiment of the paired hinging elements of a portion of the frame supporting the system.

FIG. 5 illustrates one embodiment of a hinging element in a perspective view.

FIG. 6 illustrates one embodiment of a hinging element in a cross-section view.

FIG. 7 illustrates one embodiment of the motion enabled by the hinging elements.

FIGS. 8A-8D are various views of a float.

FIG. 9 illustrates one embodiment of the structural armature of a four-set array from the top.

FIG. 10 illustrates the structural armature of the four-set array in a perspective view.

FIG. 11 illustrates the structural armature with some solar panels.

FIG. 12 illustrates the structural armature with all eight solar panels which part of the four-set array.

FIG. 13 is a perspective view of one embodiment of a portion of the panel, with some solar panels missing to illustrate the underlying elements.

FIG. 14A illustrates an alternative embodiment of a structural armature in a perspective view.

FIG. 14B illustrates an alternative embodiment of hinging elements which may be used.

FIG. 15A is a perspective view of one embodiment of a section of a large floating solar system array.

FIG. 15B shows one embodiment of how the portion illustrated in FIG. 15A fits into the larger Floating Solar System.

FIG. 15C-15E illustrate a perspective views of the mooring system attachment to the railings.

FIG. 16 illustrates one embodiment of a cart system that may be used with the floating solar system.

FIG. 17A shows an isometric view of one embodiment of the berm along a reservoir to which the floating solar system may be anchored.

FIG. 17B shows a zoomed-in view of the berm of FIG. 17A.

FIGS. 18A and 18B illustrate two views of one embodiment of the support structures on a berm for anchoring the solar system.

FIG. 19A illustrates a side view of one embodiment of the berm including the support structures.

FIG. 19B illustrates a cross-sectional view of one embodiment of the berm including the support structures.

FIG. 20 is a diagram of one embodiment of an integrated solar panel cleaning system.

FIG. 21A is a block diagram of one embodiment of the electrical system of the solar system.

FIG. 21B is a diagram of one embodiment of the electrical one-line diagram of the floating solar system.

FIG. 22 illustrates one embodiment of the connection from the racking to an on-shore equipment pad.

FIG. 23 is an in-set showing more detail of one embodiment of the connection between the feeder cables and the racking.

FIG. 24 illustrates more detail of one embodiment of the path and feeder cables.

### DETAILED DESCRIPTION

The Floating Solar System described solves several problems with putting solar panels on water, or “floating solar”, which is a fast growing niche market in the energy industry. Floating solar has several advantages over ground-mounted solar, including reduction of evaporation and algae growth in the water (up to 90% reduction of both), cooler panels due to the cooling effect of the water which makes them up to 10-20% more efficient, use of surface that would have been an under-utilized or unutilized asset before floating solar, cleaner panels due to a readily available source of water to clean the panels frequently which makes the up to 10-30% more efficient, and the ability to generate energy closer to its local use (many ponds, including waste water treatment ponds, are near urban areas where land available for ground mounted solar arrays is scarce).

The Floating Solar System allows a developer to place a solar power plant on bodies of water that are near population centers where available land is scarce. Many ponds, reservoirs and lakes are available for floating solar on portions of the water (or the entire surface if recreational use is not permitted), which lowers the line losses associated with generating energy from further away.

In one embodiment, some structural changes made to improve the system's functionality. Instead of using plastic for structural strength, the Floating Solar System uses aluminum, in one embodiment. Instead of a 15 to 20-year possible design life, the Floating Solar System has a 60-year design life due to the materials used. In one embodiment the materials include plastic, aluminum, and some stainless steel. In one embodiment, the plastic is UV resistant and is designed to be exposed to little or no sunlight, and the aluminum rails absorb all structural torque and other forces (which could weaken or break plastic if plastic were used for structural loads) also increases the usable life of the Floating Solar System. In one embodiment, the plastic is HDPE (high-density polyethylene.)

The Floating Solar System can easily withstand a freeze/thaw cycle, is convex at the bottom so if the body of water is drained or fully evaporates for any reason it won't get stuck in the mud. In one embodiment, the Floating Solar System can accept any solar panel type or size (unlike most of the existing systems), and is designed to be modular to accommodate project sizes from 10 kW to 50 GW.

The plastic forming the floating portion of the Floating Solar System is roto-molded in one embodiment, rather than blow or vacuum formed, which provides for a uniform wall thickness and incorporates engineered ribbing for strength and durability.

In one embodiment, the Floating Solar System can be designed in increments of 10 kW and larger, in any configuration that is divisible by 10 kW DC. Standard sizes are solar panel arrays of: 10, 50, 100, 500 and 1,000 kW DC, and the final size can be configured with any combination of these standard sizes.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

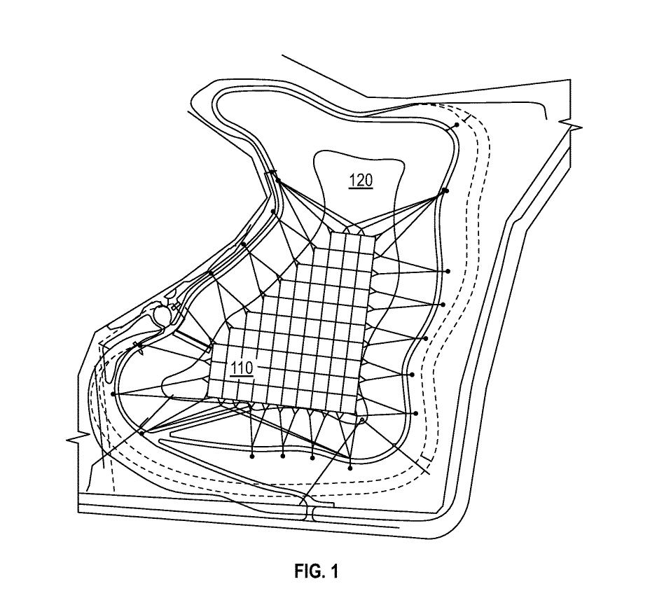

FIG. 1 illustrates one embodiment of a Floating Solar System in a small area of water. This example illustrates a system which covers the entirety of a small reservoir or similar water area. The Floating Solar System is anchored to the berms along the edge of the reservoir. In one embodiment, the anchoring structure does not drill down into the berms. The rectangular elements within the Floating Solar System represent a block of solar panels and associated structures. The strands extending from the armature and panels to shore are moorings R (RE, RN, RS, RW are the east, north, south, and west moorings. In one embodiment, the anchors are on top of a berm surrounding the reservoir or other water structure. Element 5 is the pathway to lead the electrical wiring from the solar panels to a pad mounted element 6. From there, the electrical system is coupled to the utility power, as will be described in more details below.

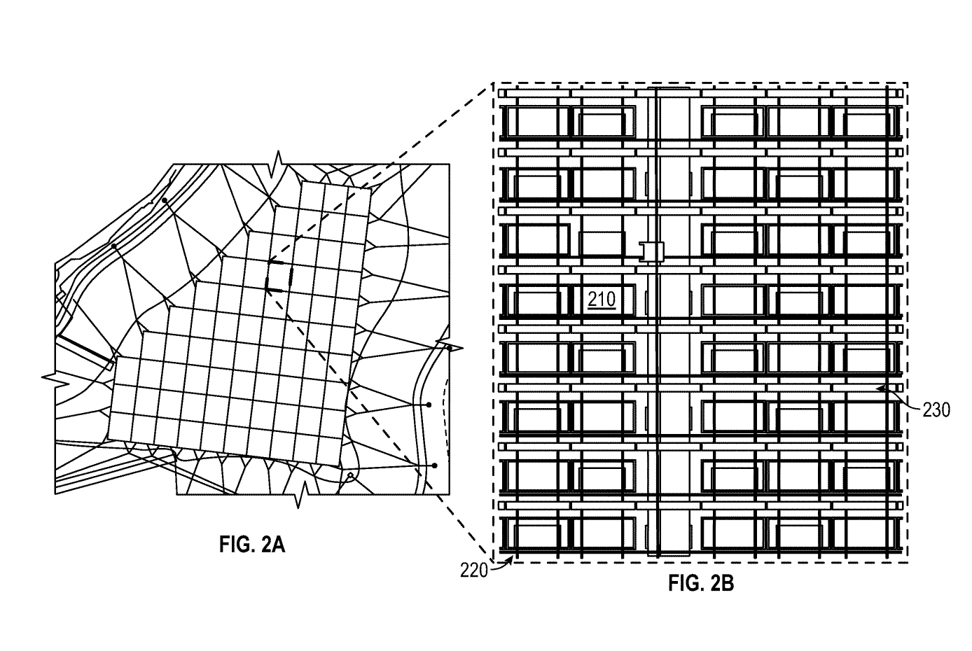

FIG. 2B illustrates an exemplary set of solar panels, and association elements that make up one block, identified in FIG. 2A, of the Floating Solar System of FIG. 1. The exemplary block consists of 40 solar panels (210) and associated structures. The illustration of FIG. 2B shows the support structure elements (220) and walkway elements (230).

FIG. 3 illustrates an exemplary float set in a perspective view. The float set 300 includes two solar panels 360, over a metal structure 310, with an associated float to provide support. The illustration of FIG. 3 provides measurements. It should be understood that these are exemplary measurements. In this example, the racking structure 310 is 12′ by 6′6″ and supports solar panels 360 separated by metal walkways 330. The racking structure 310 in one embodiment is 6061-T6 aluminum tubing. In another embodiment, the rails may be fiber-reinforced polymer (FRP). In one embodiment, the walkways may be hot-dipped galvanized.

This provides a light weight but structurally strong framework which is able to support the solar panels as well as full grown adults on the walkways 330. In one embodiment, the metal walkways 330 are 10″ thick, and run along the length of the Floating Solar System.

These materials and parts may be interchangeable. For example, all steel parts with marine coatings may be preferred in salt water environments. Various combinations and compounds of fiberglass, plastic, ceramic or basalt fiber materials may be used as the racking framework of the Floating Solar System.

The rails making up the racking structure 310 are coupled via aluminum couplings to other float sets. As will be described in more detail below, the couplings in one embodiment enable each of the float sets to move with respect to each other. This permits the Floating Solar System to move with waves and even ride out storms, without capsizing or otherwise being damaged. The racking armature supports all PV and associated hardware, anchoring attachments, electrical equipment, walkways, and service personnel and related equipment.

The solar panels 360 are supported by module brackets and clamps 340. In one embodiment, the solar panels 360 are positioned at an angle. In this example, they are positioned at a 22-degree angle. In one embodiment, this angle is customized based on the environment in which the Solar System is installed.

Because the Floating Solar System uses metal as an armature and structural support of solar panels, it is superior in strength to other floating systems that use plastic for structural support. The wind tunnel ASCE certified tested pitch angle of 22 degrees is a significantly steeper pitch angle than the prior art (pitch angle is proportional to wind load). The steeper pitch angle will result in higher energy production for every locality in the continental United States and Canada. This is counterintuitive, but has been tested.

The float provides floatation and is made of plastic. In one embodiment, the plastic may be high-density polyethylene (HDPE). In one embodiment, the plastic may be Linear Low-Density Polyethylene (LLDPE). In one embodiment, the plastic may be recycled LLDPE, or other plastics. In one embodiment, each set of two solar panels includes one float. In another embodiment, each solar panel may have a float associated with it.

The float 350 is shaped to have a rounded bottom and a flat top, enabling it to be attached to the racking structure 310. The rounded bottom of the floats 350 keeps the system from becoming stuck if the reservoir is empty or nearly empty.

The illustrated exemplary configuration of FIG. 1, a 1 MW AC block is made up of approximately 1,650 “Float Sets”. Each Float Set in one embodiment consists of the following: (1) float 350, (2) photovoltaic (PV) modules 360, (2) 12′ North-South rails 310, (4) 6′6″ East-West rails 310. Float sets are attached to each other via hinged attachments (racking couplings).

A smaller unit, such as a 40′×40′=10 kW AC block may be made of a smaller number of blocks. In one embodiment, the arrangement of the Float Sets may be square or rectangular, or another shape, based on the configuration of the pond or other water area on which it is designed to be placed. In one embodiment, conduit raceways are affixed to the floats to carry the electricity generated from the Floats to shore. In one embodiment, the pathway from the Floating Solar System to shore may be supported by racking, a walkway, and matching floats. The transmission cable may be above or below water.

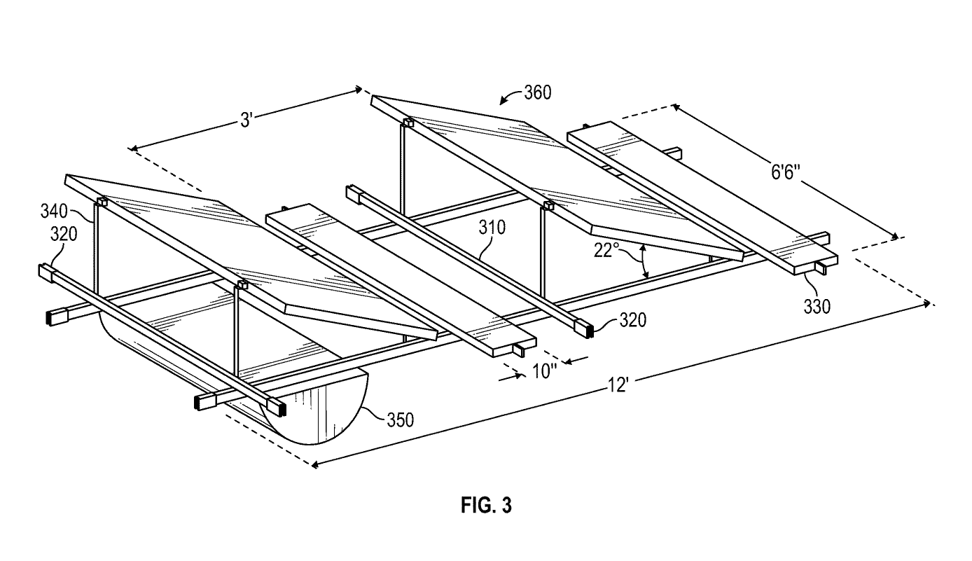

FIG. 4 illustrates one embodiment of the hinging of the system. Both the rails and walkways are hinged to allow movement between the float sets. In one embodiment, the rails are attached with through-bolts 420. The walkways are attached via couplings. The walkway hinge bolts are aligned coaxially with the east-west coupling bolts. This alignment ensures that the element can move. In one embodiment, the bolts are stainless steel 316.

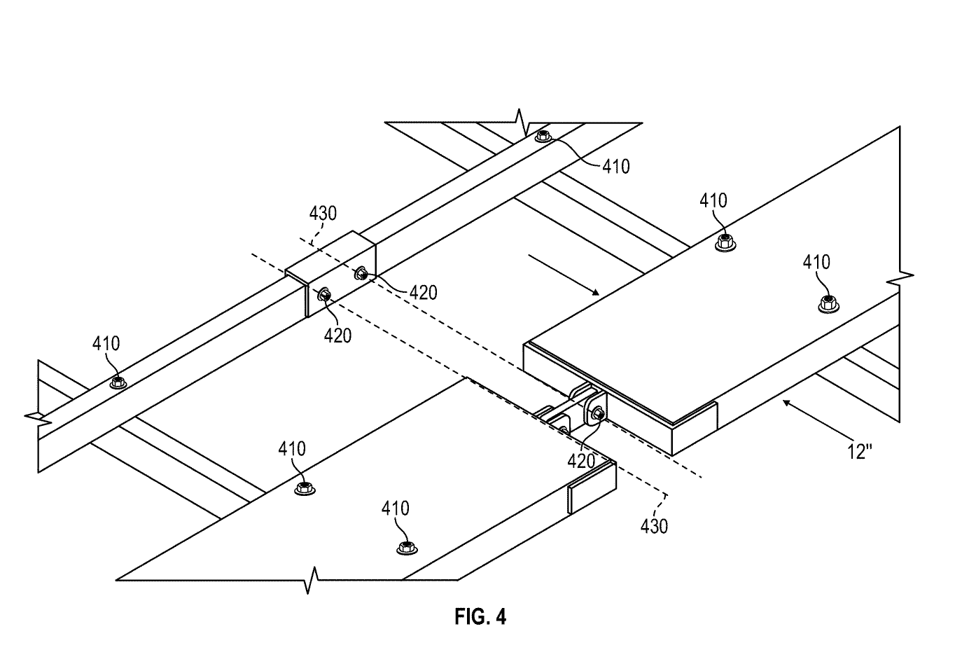

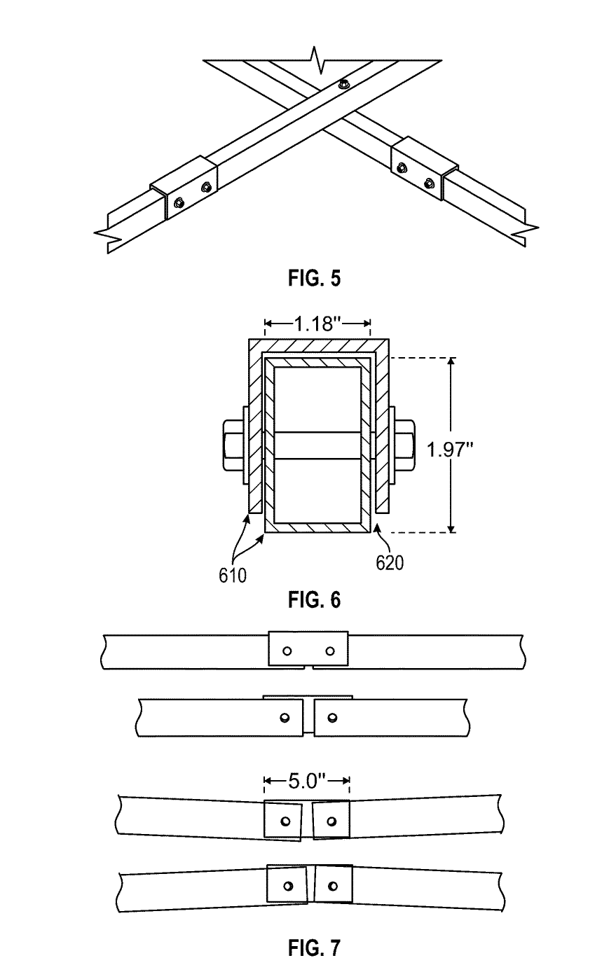

FIG. 5 illustrates a perspective view of one embodiment of the crossing of the east-west and north-south railings. As can be seen, every set is hinged so it can move slightly upward and downward. In one embodiment, the railings are bolted together at the crossing points.

In one embodiment, the railings may also provide a network of rails for service vehicles and maintenance carts to travel on. Sled trays can be pushed or ride along these rails as well as electric and non-electric wheeled vehicles. This may be used, for example, to enable in-situ replacement for solar panels by enabling the taking of the panel and gears onto the racking.

FIG. 6 shows a cross-section of one embodiment of a railing. In one embodiment, both the railing and the coupling are made of aluminum. In one embodiment, the cross-bolts are made of stainless steel. In another embodiment, the bolts are made of aluminum. The railing fits within the coupling, and the coupling is larger than the railing. The spacing between the interior of the coupling element and the railing provides space for motion.

FIG. 7 shows a side view of the rails and coupling. The coupling is separately bolted to both the railings. In one embodiment, the rails have smaller diameter holes than the couplings. FIG. 7 shows the motion permitted by the coupling. The railings can move up and down with respect to each other. In one embodiment, the railings can move up to 5 degrees, in either direction, providing up to 10 degrees of total differential.

As noted above, in one embodiment the rails have smaller diameter holes than coupling holes rails can hinge slightly upward and downward at every coupling. Space between the coupling inner wall and railing outer wall allows for non-binding movement. Coupling hinge bolts are affixed to the coupling. The larger size railing bolt holes allow the railings to hinge freely a few degrees upward and downward. The railings' hinge movement is restricted by the upper wall of the coupling.

Rail couplings primarily allow movement in the vertical dimension, and only slight movement in the horizontal dimension. By design, the couplings allow the float sets to move freely and absorb any rocking movements caused by waves, otherwise rails could bend or fatigue when vertically loaded. However, lateral forces caused by winds, place the rails in compression and tension and these loads play to the strengths of the rails and limited coupling movement.

The racking couplings are the hinged attachments that join adjacent Floating Solar System sets together. In one embodiment, a set is rigidly bolted together combination of rails, float(s) and PV module(s). In one embodiment, rail couplings are shaped as a short channel. This design keeps the joint from collecting any water or debris. Rail couplings allow a full range of rail movement under any environmental condition, including storm waves. However, the couplings stop the rails from completely “hinging” when they are lifted during initial assembly. The rail holes are larger than the coupling holes at the point of coupling. This allows for a limited but additional movement of compression or tension throughout the array system, adding to the flexibility of the entire array system.

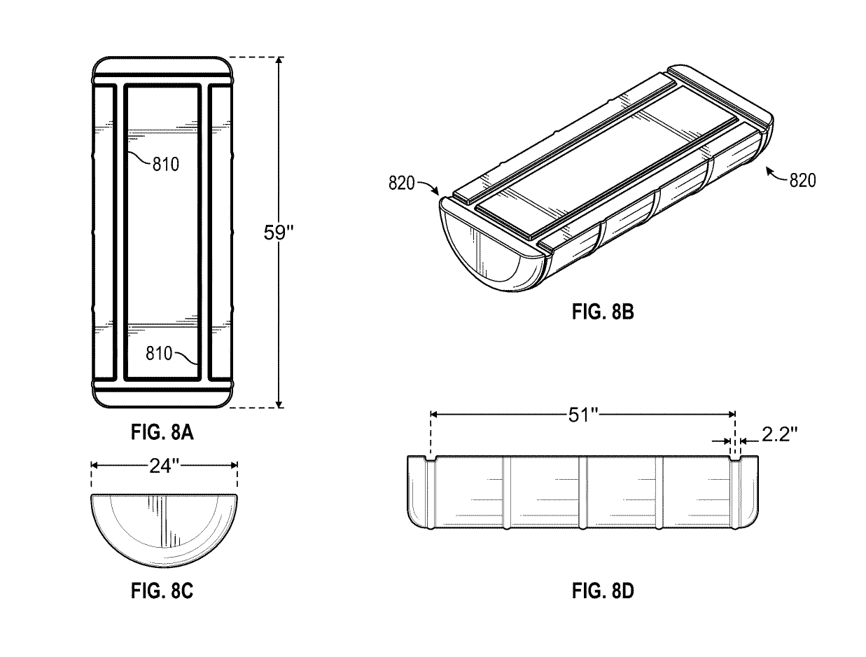

FIG. 8A-8D illustrate various views of one embodiment of the float. The float is designed with a flat top, which is coupled to the rails. The grooves in the float, shown in FIG. 8A are designed to fit to the rails. The bottom of the float is rounded, so that the Floating Solar System does not flounder in mud. In one embodiment, the float has an overall shape of a half-cylinder.

Floats have indented ribbing in one embodiment. This ribbing strengthens shell surfaces and accepts the profile of the attached aluminum rails—minimizing rail fasteners.

The floats may be roto-molded HDPE, which provides a structurally superior format compared to blow or vacuum forming because it creates a float shell with a uniform wall thickness.

In one embodiment, the shape of the float top sheds all water, preventing water pooling, which provides mosquito habitat. In one embodiment, the floats have internal holes or attachment points for accepting rail bolts. Internal holes are stronger than protruding or overhanging ear attachment points

In one embodiment, the float footprint is smaller than the associated PV panel. This means that the float hides under canopy of PV—preventing UV degradation, because it receives no direct sunlight and no refracted sunlight. In one embodiment, the floats are sized to be covered in shade approximately 95-100% of the time.

The smaller float footprint and the fact that the panel does not rest directly on the plastic float like most other products allows for maximum convection of air flow throughout racking system, increasing panel cooling and PV efficiency. The raised design can accommodate a bifacial solar panel, to collect additional energy from sunlight reflecting off of other surfaces due to the albedo effect.

In one embodiment, the use of a float with rounded bottom and sides will easily release foreign material, because it sheds algae, floating plant life, etc. The rounded bottom also will release from mud or reservoir bottom if floats are ever “beached.”

The Floating Solar System utilizes the plastic floats for floatation. However, structural support is provided by aluminum (or carbon fiber, which is stronger than aluminum). No stress, laterally or otherwise, is placed on the HDPE other than the weight of the island on the floats.

The bottom of the Floating Solar System has a convex cylindrical shape, in one embodiment, so “beaching” would be highly improbable. Testing has shown that repeated exposure to mud or silt, then a subsequent introduction of water (e.g. refilling of the reservoir by rain or other means) easily pulls the Floating Solar System out of the mud. The buoyancy of the floats exceeds the ability of mud, clay or silt to grab onto a curved, convex surface.

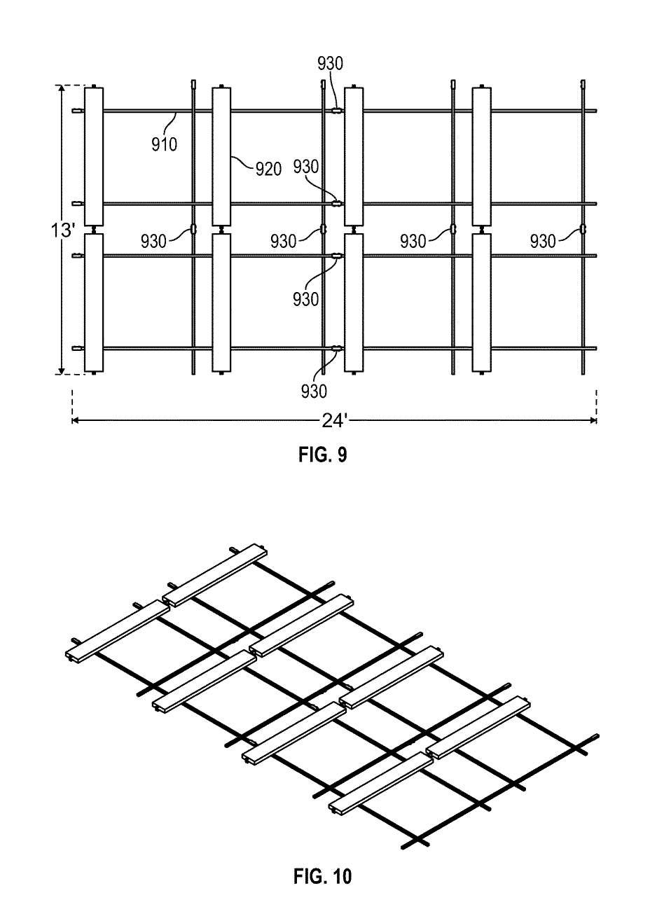

FIG. 9 illustrate a portion of the racking from above, including the walkways. FIG. 10 illustrates the same walkway in an isometric view. FIG. 9 illustrates four rail sets coupled together to form a solar array. The four quadrants of the array hinge at the couplings (930) and along the couplings' north-south and east-west axis. Each rigid set moves independently from one another as wind and waves travel across the array. Arrays can be assembled from thousands of sets to aggregate electrical energy.

The racking includes rails 910 running in the north-south and east-west direction, which are attached with bolts. Of course, these directions are arbitrary, and used as descriptors only. As described above, the rails are hinged periodically with hinges 930. In one embodiment, there are hinges 930 every 12′ in the east-west direction, and ever 6.5′ in the north-south direction. In addition to the railings 910 there are walkways 920 which run in the north-south direction, in one embodiment. The walkways double as structural members, and also provide an access to the array for service personnel.

To address the issue of heat—solar panels get hot during the summer, which reduces their efficiency—in one embodiment the Floating Solar System utilizes aluminum racking in direct contact with the solar panels. The aluminum transfers the cooling effect of the water to the solar panels, and the solar panels stay cooler to their close proximity to the water.

The strength of aluminum racking allows for greater cumulative loading compared to HDPE armature racking. The Floating Solar System array can become much larger than an HDPE armature racking system, using only shore anchors. An HDPE armature racking system is more likely to require submersible anchors for any large size system array because HDPE has a lower specific strength than aluminum and, therefore, requires more mooring support per linear foot to secure the array.

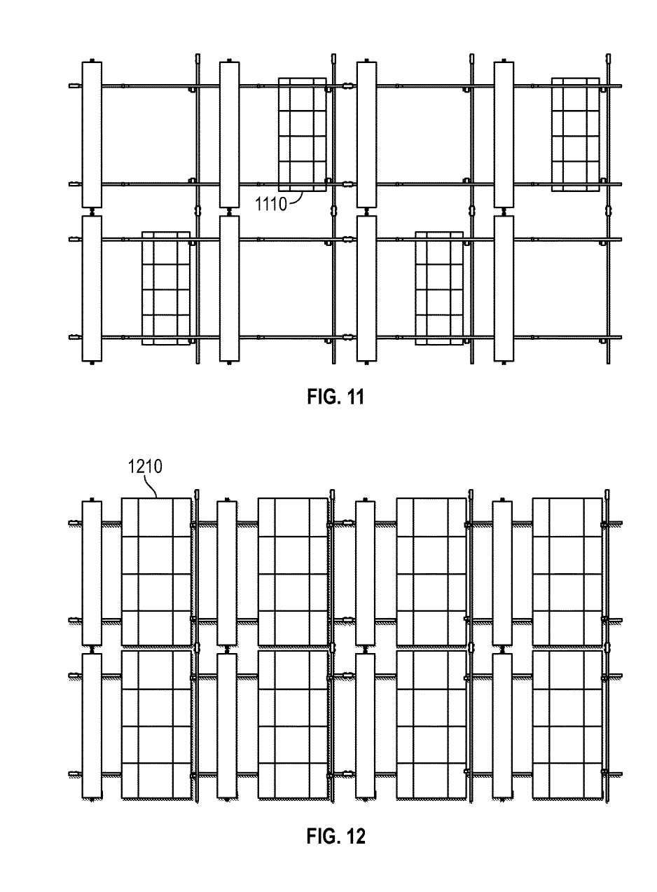

FIG. 11 shows the rack from above, including a subset of the solar panels. FIG. 12 illustrates the same rack with all solar panels attached. As can be seen, this unit of eight solar panels includes associated walkways for each solar panel. The floats are beneath the solar panels and thus not shown.

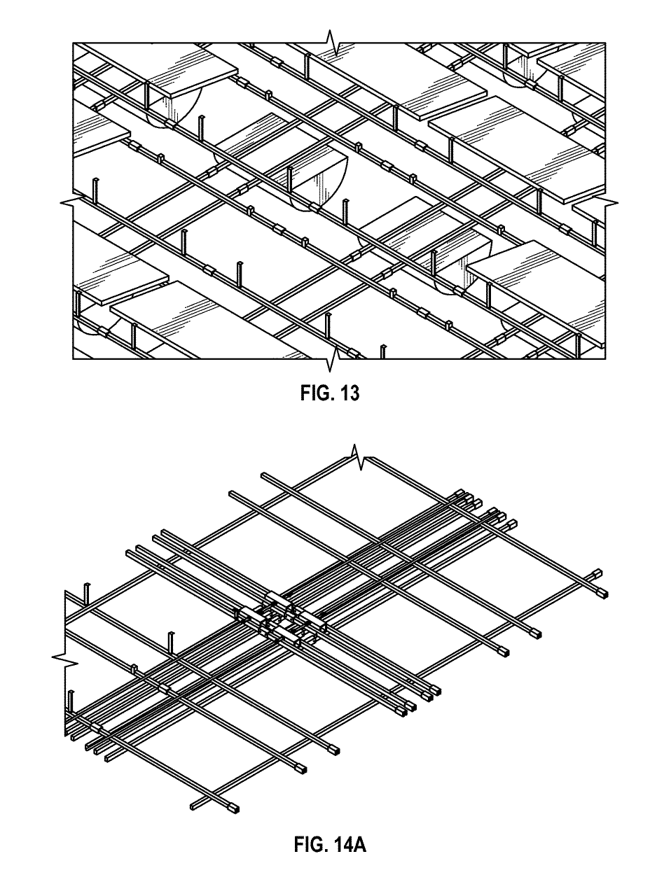

FIG. 13 shows a perspective view of one embodiment of a racking, with some of the solar panels removed, and showing the floats. In one embodiment, the floats are positioned in alternating rows. In another embodiment, the floats may be positioned in a checkboard or other pattern. In one embodiment, the exterior portions of the Floating Solar System may have more floats than the center area. Other ways of arranging the floats may be used.

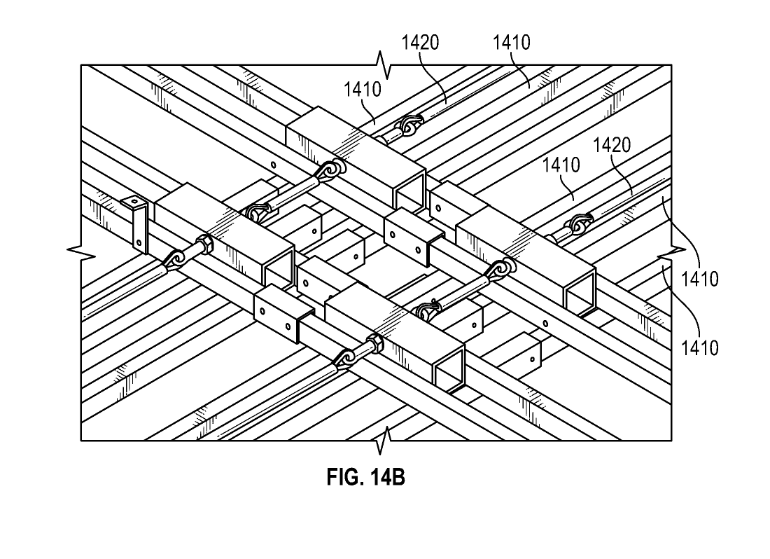

FIGS. 14A and 14B illustrates an embodiment of the racking, in which interior cables are used. In that illustration, only the N-S cables are shown. The short cable slings are adjusted using the nuts. The long cable slings come together in a bridle (not shown) and attach to a turnbuckle (not shown). If walkways are not installed between every row, then east-west rails replace the walkways to complete the racking framework structure. This is illustrated in FIGS. 14A and 14B, where two solar panels are removed to illustrate the matrix of rails without walkways.

In one embodiment, the extra high strength (EHS) cables are also used internally throughout the Floating Solar system array. That is, steel cables may run beside major walkways absorbing major and cumulative lateral loads as the arrays become hundreds of yards long. Similar to the Golden Gate Bridge where the entire load and supporting network hangs off the suspension cables, these internal tension cables lay flat on the aluminum rails and only attach every 150′ or so.

As solar array size increases, so does the potential wind load and need for additional structural and mooring support. In one embodiment, the system may include stronger or larger sized railing intermittently within the array. In one embodiment, additional rails may be positioned in close proximity to provide a stronger element, using rails of the same size.

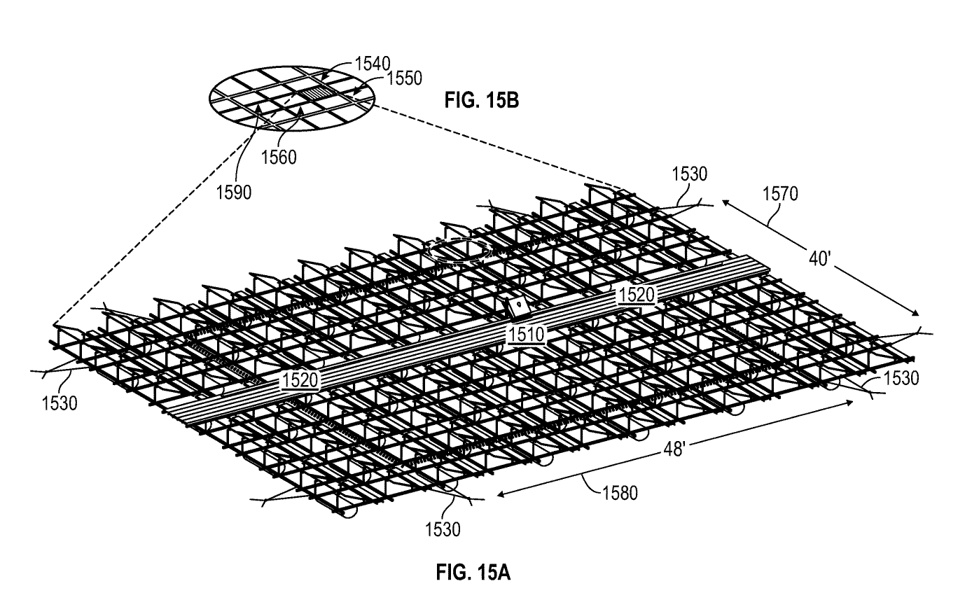

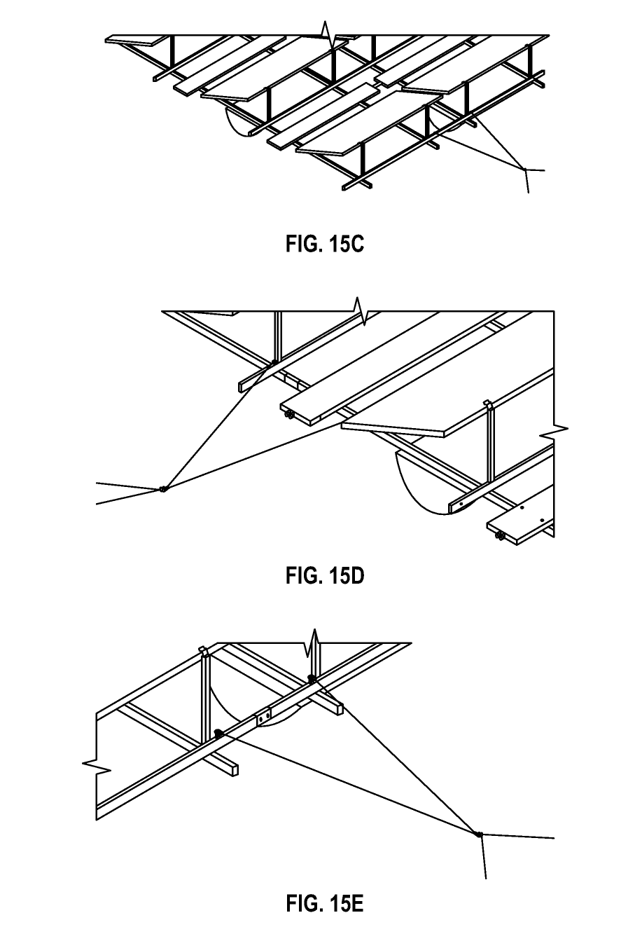

FIG. 15A illustrates a composite representation one embodiment of a floating solar system. This may be part of a larger system, as shown in FIG. 15B. The illustration is translucent, so the floats can be seen despite them generally being covered by solar panels. Solid filled array (shown as parallelogram—1560), consists of 48 solar panels—also shown as dotted bordered parallelogram. It can be seen in this figure that railings of two different sizes are used. In one embodiment, the heavy lines in east-west dimension (1540) are rails sized at 30 mm×50 mm×5 mm (rectangular tubing). In one embodiment, the heavy lines in north-south dimension (1550) are rails sized at 50 mm×50 mm×5 mm (rectangular tubing).

In addition to the railings and floats, the system shows some of the electrical elements used to move the power generated by the solar panels. In one embodiment, an electrical combiner box (1510) is mounted on the walkway. The electrical cable tray or conduit (1520) for transmitting the electrical power is positioned in the center of this element. In one embodiment, electrical cable tray or conduit (1520) is positioned every two to four rows of solar panels.

Additionally, FIG. 15A shows one embodiment of mooring cable bridles (1530) which attach the mooring cables to the racking. These mooring cables stabilize the Floating Solar System. In one embodiment, the anchor frequency along the east-west perimeter is 40′ while the anchor frequency along north-south perimeter is 48′. However, the anchor frequency may be altered based on local conditions.

The Floating Solar System racking described is a strong and durable foundation. It may be further used for supporting single-axis and dual-axis tracking solar systems. Tracking tubes used in the solar industry for changing the pitch angle of the solar panels, can be mounted on the armature. In one embodiment, the system's tracking tube would span the length of a single section, enabling flexibility. In one embodiment, the individual tracking tubes may be connected to an adjoining tracking tube by a simple u-joint, thus maintaining the flexibility of the armature. In one embodiment, the described system can also be installed as an azimuth tracking system. In this embodiment, a large pier driven into the center of the reservoir provides the center bearing axis point and anchoring for the Floating Solar System to revolve around. Such modifications to the system may be made, without straying from the present invention.

FIG. 15C is a view of one embodiment of the north-east corner of the array of FIG. 15A, showing the attachment of the mooring cable bridles 1530. FIG. 15E is a close-up of the same view. In one embodiment, they are attached to two railings and associated module brackets supporting solar panels. In one embodiment, the mooring cable straddles a coupling on a northern array perimeter. FIG. 15D is a close-up view of the mooring system along the eastern array perimeter. In one embodiment, the mooring system is attached on either side of a walkway and a coupling. In one embodiment, all mooring line bridles straddle a coupling, such that each cable leg of the bridle is affixed and flexes with its corresponding side of a coupling.

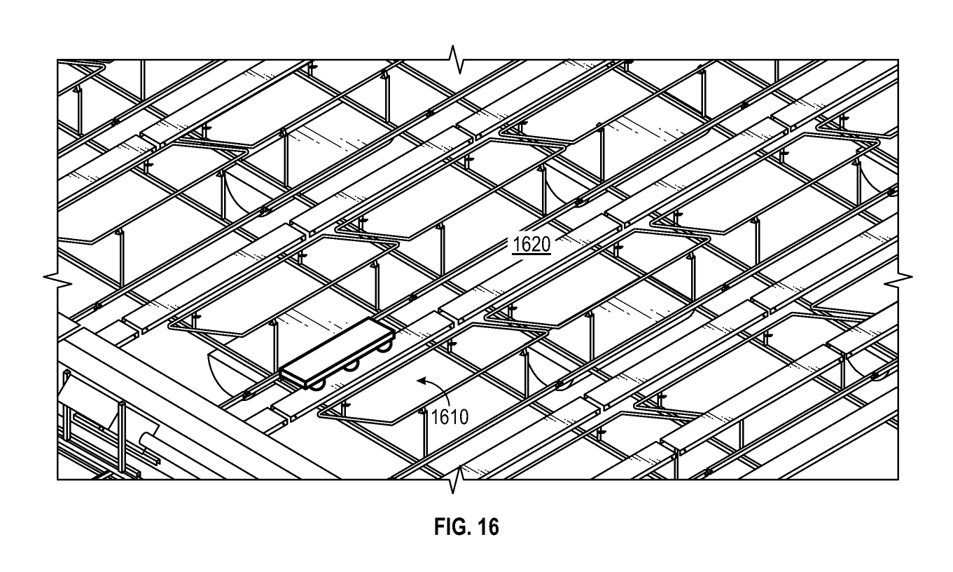

FIG. 16 illustrates one embodiment of using a cart system. Because the Floating Solar System has rails that run parallel and unimpeded, these rails may be used to provide a rail system for carts (1610). This may be used for service people or equipment transport. In one embodiment, carts travel in an east-west direction (1620) on rails and a north-south direction on walkways. In one embodiment, a cart runs with one set of wheels on a rail and a second set of wheels on the parallel walkway. Additionally, or alternatively, carts could span multiple rails and/or walkways, to provide a large scaffold-like platform for carrying larger items such as replacement solar panels, or a washing system.

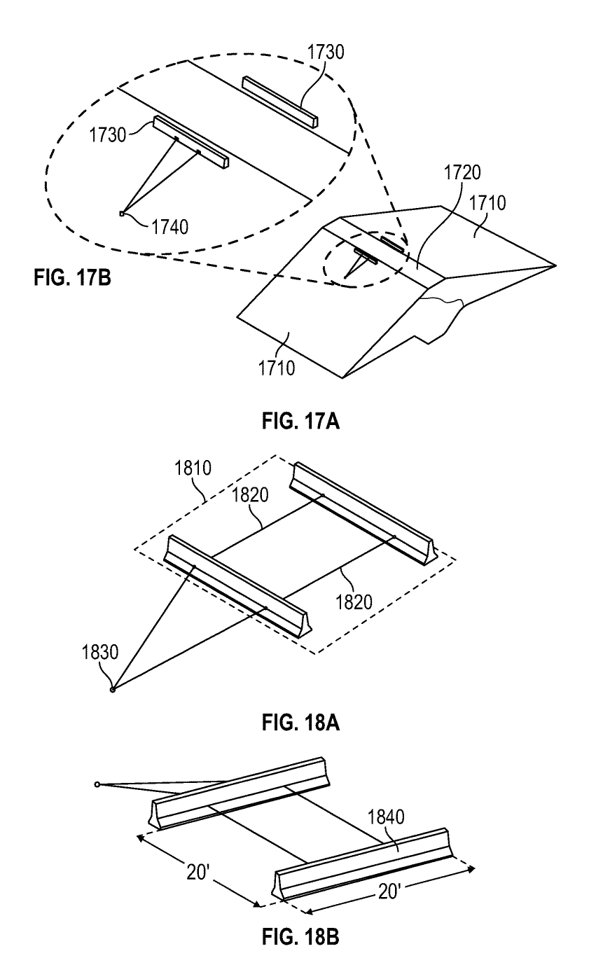

FIG. 17A is an isometric view of a berm, which surrounds a typical reservoir. A berm is a man-made sediment barrier placed at the edge of a slope or a wall built adjacent to a ditch to guard against potential flooding. The mooring of the Floating Solar System is coupled to the top 1720 of the berm 1710. Often, there is a service road on the top of the berm 1720. Generally, drilling deep into the berm 1710, sufficiently to provide strong anchoring for the Floating Solar System is discouraged, as there is concern that this would weaken the berm. Submersible anchors have numerous disadvantages, compared to shore anchors, including potential issues with reservoir liners, expense, water displacement, difficulty with inspection and maintenance. Additionally, anchor blocks or other submersible anchor system may become an obstacle or problem if the reservoir drains and the floating system becomes lodged on top of the anchor blocks. Therefore, in one embodiment, the anchoring system used requires no drilling deep into the berm, and does not utilize submersible anchors.

FIG. 17B is the inset of FIG. 17A. As can be seen, two concrete blocks (1630) are positioned on either side of the top 1620 of the berm 1610. In one embodiment, the concrete blocks may be standard k-rail concrete blocks. These blocks are often used during highway construction. This makes such concrete blocks 1630 easily available with well understood characteristics. In one embodiment, the concrete blocks 1630 are partially buried into the side of the berm. The concrete blocks 1630 are tied together with a cable that runs underneath the top of the berm 1620, the two ends joining to make a mooring bridle (1640). For simplicity, the application will refer to the concrete blocks 1630 and k-rails. However, alternative concrete blocks may be used.

The two k-rails 1630 together form a k-frame anchoring system.

FIG. 18A shows an isometric view of one embodiment of a k-frame anchoring system (1810). The two k-rails and a single extra high-strength (EHS) galvanized cable (1820), looped and joined at the ends, produce a single anchor point (1830). The mooring line of the solar array will be attached to the anchor point (1830). FIG. 18B shows an exemplary set of dimensions for the k-frame. As can be seen, the cable 1720 extends between the two k-rails. This portion of the cable however is buried.

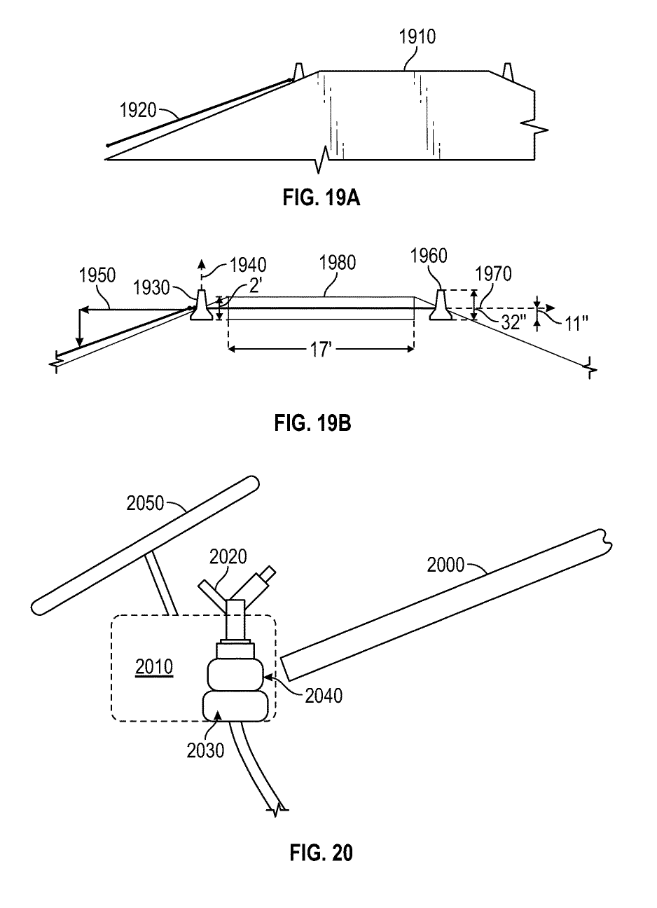

FIG. 19A illustrates a side view of one embodiment of the k-frame anchoring system, showing the berm as a solid volume. Note the top of the berm or road surface (1910) and the inside slope of the reservoir berm (1920). FIG. 19B shows one embodiment of the k-frame on inside of reservoir berm (1930), as a cross-section or equivalent. The k-rail provides upward vertical force (1940) resistive to the vertical component of the applied mooring line force (1950). The mooring line is pulling from a solar array positioned at a water level assumed to be below the horizontal plane of the k-frame.

The k-rail on the outside of the reservoir berm (1960) provides a lateral force (1870) resistive to the lateral component of the applied mooring line force (1850). The volume of the rectangular block of soil (1980), in one embodiment as shown with the dimensions 17′×2′×20′, provides the resistive ballast load to act against the lateral pulling force of the outside k-rail (1960).

The volume and thus weight of the ballast block (1980) may vary depending upon the road width, length of k-rail and k-rail depth of embedment. The size of the ballast weight is determined according to mooring line load. These loads will vary, and in turn k-frame sizing will vary depending upon the direction of the wind as it blows across the array from different angles. In one embodiment, wind loading values on the array are calculated from wind tunnel test results and array size.

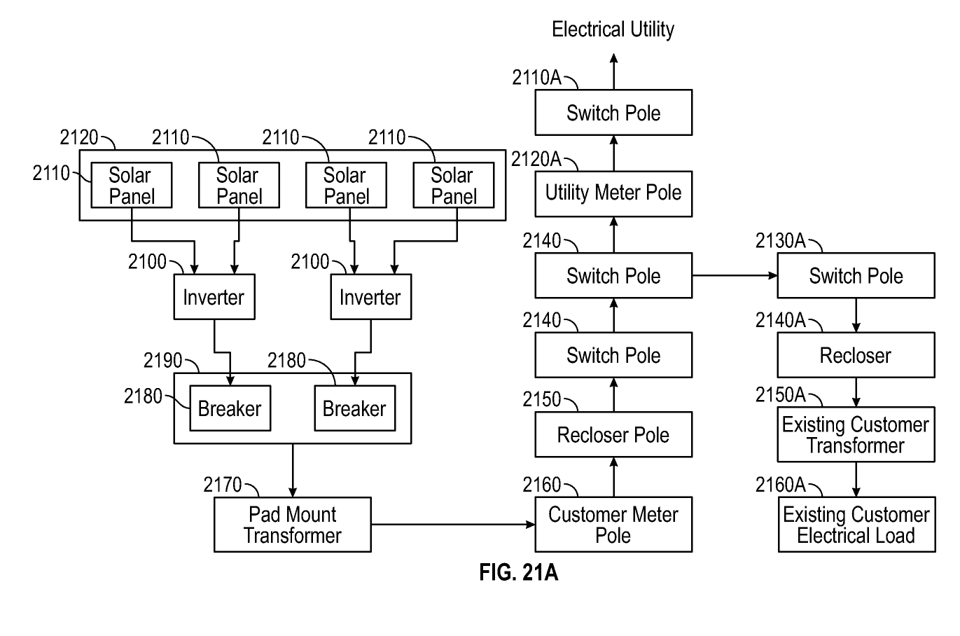

Solar power plants are generally subject to soiling (dust accumulation) which degrades the performance by up to 25-40% without regular panel washing. The Floating Solar System has ready access to a water source, and in one embodiment has an automatic panel washing feature, illustrated in FIG. 20, included as an option to wash the panels regularly to keep them cleaner by far than a comparable sized ground mounted project.

In one embodiment, the panel washer includes a 1.5″ high flow rate agricultural commercial grade rotating sprinkler 2020 powered by a pump 2030. In one embodiment, the pump 2030 may be a variable DC drive Grundfos. In one embodiment, the pump 2030 may be powered by a dedicated solar panel 2050. In another embodiment, the pump 2030 may obtain its power from the solar panels 2000.

In one embodiment, the panel washer includes high volume water filtration 2030, and utilizes a battery and timer (controller 2040). In one embodiment, the panel washer may be automatically initiated with a certain period. In one embodiment, this period may be pre-set based on local conditions. Those conditions, in one embodiment, may be seasonally varied, so for example the panels are washed more frequently during springtime than during mid-winter. In one embodiment, the periodicity may be updated remotely.

In one embodiment, the panel washer may be triggered when the power obtained from the solar panels falls below a threshold. In one embodiment, that threshold may be dependent on the season and weather. In one embodiment, the panel washer may be triggered using a manual or wireless control. In one embodiment, the timer is Wi-Fi connected. The elements of the panel washer may be contained in a compartment 2010, such as a National Electrical Manufacturers Association (NEMA) certified enclosure. In one embodiment, the range of the sprinkler is approximately 20-30 meters radius, and therefore may be mounted on the edge of each 20 kW portion of the array, along the outside edge or the walkway to minimize the amount of sun blocked.

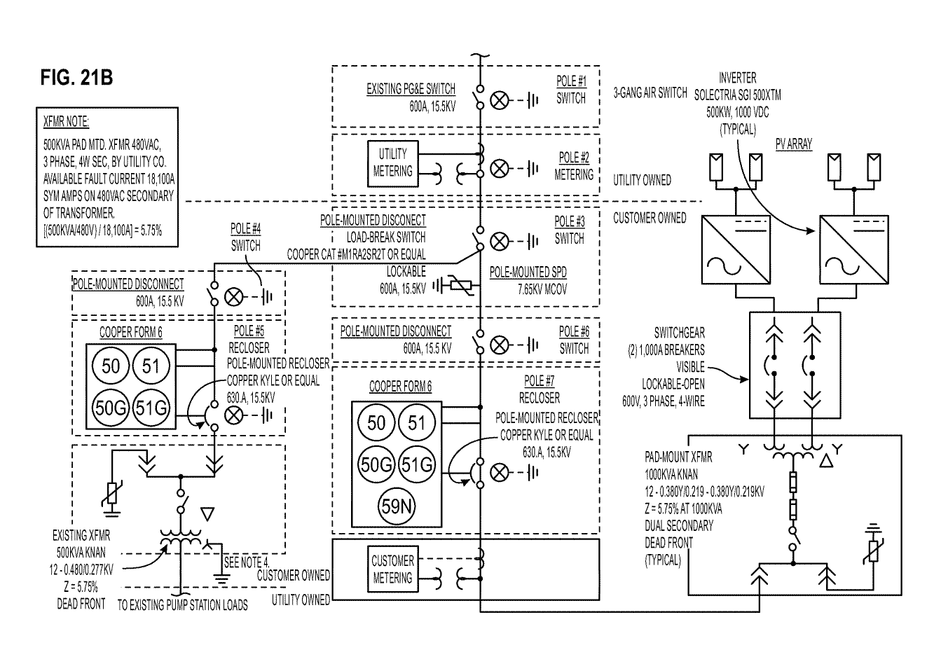

FIG. 21A illustrates one embodiment of the electrical configuration of the floating solar system. The entire floating system 2120 includes a plurality of solar panels 2110. The outputs of the solar panels are collected, and lead from the floating system to shore. In one embodiment, there are two inverters 2100, on shore. In another embodiment, each solar panel 2110 may have an associated inverter 2100. The numerous subpanels and strings of the floating solar (2110) array are shown. The subpanels and strings (2120) includes the electrical DC components of the solar array. Most of this equipment resides on the water, except for the DC feeders which bring the DC power to the inverter pad on land. In one embodiment, the customer can remove electrical load from the electrical utility, but keep the solar system running by opening the air-switch (2130). The recloser (2150) provides vault protection for the customer load. The customer transforms their 12,470 volts to 480 V AC to run their equipment with the transformer (2150A). The customer's electrical load is (2160A).

Switching gear 2190 includes breakers 2180. In one embodiment, the breakers 2190 are 1000 Amp breakers. Each breaker provides isolating current protection for the inverter 2100. Pad mounted transformer (2070) is the interconnection transformer, typically dropping the 12,470 DC volts to the inverters' 480 V AC or 380 V AC. Pad mounted transformer 2170 in one embodiment is positioned near the top of the berm.

FIG. 21B illustrates the circuits in more detail. The utility feeder line that interconnects with the solar array enters the solar site at FIG. 2110. There is a 3-gang air switch on this pole that can isolate the solar site from the utility 12,470 volt electrical line. The electrical utility often attaches a utility meter on the meter pole (2020) to measure the net capacity of the solar site's electrical generation. A load-break disconnect switch (2030) allows the customer to isolate the utility equipment from the customer equipment. An air disconnect switch (2040) will disconnect the solar array from the utility without disconnecting the existing customer load.

The recloser (2050) along with a cooper form 6 controller monitors frequency, voltage and will open the feeder circuit if such values are outside acceptable parameters. A recloser has the ability to reset automatically after a fault. The revenue meter pole (2060) for the customer measures the net kwh of the solar plant. The interconnection transformer (2019), typically drops the 12,470 volts to the inverters' 480 V AC or 380V AC. In one embodiment, there are two 1000 Amp breakers mounted in the switchgear (2090). Each breaker provides isolating current protection for each inverter. The switchgear (2090) can isolate the breakers from the transformer. Each 500 kW inverter takes DC current and voltage generated by the solar array and converts it to ac current and voltage.

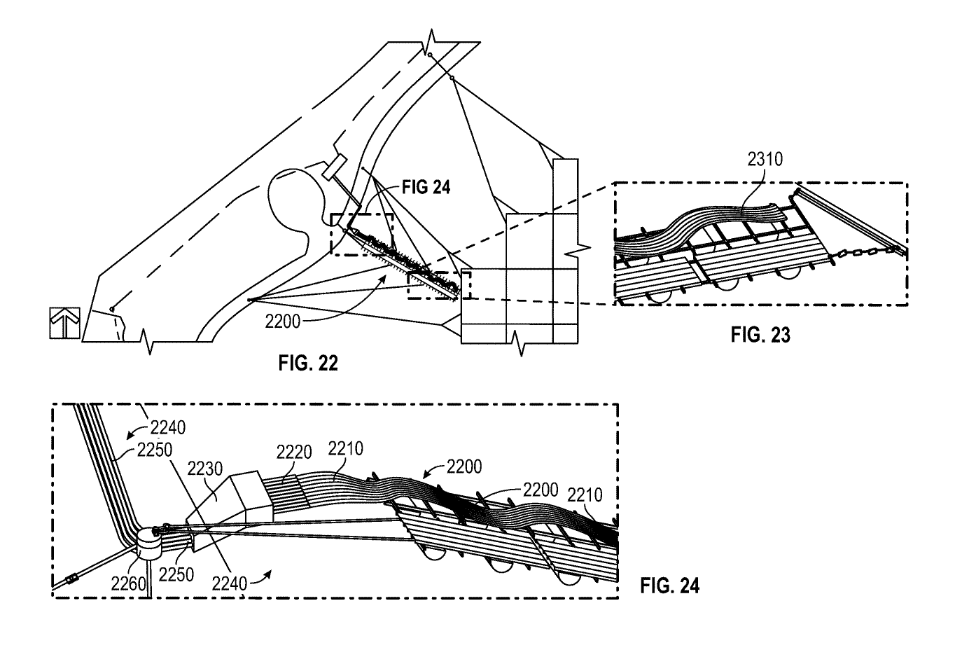

FIG. 22 illustrates one embodiment of the connection from the racking to an on-shore equipment pad. The pad, in one embodiment, is the pad mounted switching gear discussed above with respect to FIG. 21. As can be seen, the pathway 2200 from the racking to the equipment pad provides a way for the electrical connection from the edge of the racking to shore. It is anchored at the shore, and then lead to the equipment pad. Because of the configuration of the feeder cable, the electrical connections are also able to handle waves and the changes in water level.

The solar panels of the floating array are electrically grouped, i.e., wired in series, to create a higher voltage circuit. These circuits are called strings. In one embodiment, each string connects to a combiner box mounted on the array and is equipped with fused protection. When the strings combine in the combiner box their currents combine, and a larger feeder cable carries this DC power across the array, onto land, connecting to the inverters.

If the water level of the reservoir changes over the course of the year, then the solar array will be rising and lowering as well. The mooring lines and feeder cables will need to be long enough to account for this vertical difference and must safely span the distance from array to shore when the water is at its lowest level. When the water returns to its highest level, there will be slack in the mooring lines and electrical feeder cables. Thus, the ratio between the distance of array to shore and water level difference is should be large. This ratio is called “scope”. An anchoring design with a large scope will have a small amount of “slack” in mooring lines and electrical cable even when the delta of water levels is large.

FIG. 22 illustrates a walkway and adjacent electrical pathway 2200 that accounts for a variation in reservoir water level heights. The feeder cables (2210) are tied loosely to the pathway in a serpentine layout so their length can expand and contract. The feeder cables are housed in flexible conduit. In one embodiment, a second layer of flexible conduit housing (2220) provides additional strain relief for the cables as they enter the stationary concrete electrical vault (2230), located at the top of the reservoir berm (2240). In one embodiment, the electrical feeder cables continue underground (2250) to the inverter pad.

FIG. 23 is an in-set showing more detail of one embodiment of the connection between the pathway 2200 and the racking. In one embodiment, the feeder cable 2310 is coupled to the solar array via dual connections, allowing the feeder cable to move with respect to the array. In one embodiment, the coupling may be via a chain, or one or more bolted connections.

FIG. 24 illustrates more detail of one embodiment of the pathway consisting of rails supporting a path and feeder cables. In one embodiment, the support structure for the feeder cables 2210 resembles the structure of the racking, with paired walkway and feeder cables in parallel. The pathway hinges at the array anchor point 2310, and at the berm anchor point 2260.

The walkway may be used to approach the solar panels on foot, in one embodiment. In that embodiment, the spacing between shore and pathway and the solar array and pathway are set to enable an adult to step from one to the other. In one embodiment, the walkway and feeder cables provide protection from the sun for the floats to avoid degradation of the material. As can be seen in this illustration the feeder cables are in one embodiment periodically anchored to the rails of the pathway, but with enough looseness to permit movement without causing strain on the cables. In one embodiment, the amount of play given to the feeder cables depends on the expected changes in water level and expected level of waves.

At shore, the racking is anchored to anchor bolt 2260. The feeder cable is positioned in a weaving pattern, in one embodiment, allowing flexibility and movement without causing damage to the cable. The cable from the anchor point lead to the equipment pad.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A floating solar system comprising:
solar panels;
a racking structure having a top and a bottom, the racking structure comprising a plurality of an aluminum rails, the solar panels attached to the top of the racking structure; and
plastic floats attached to the bottom of the racking structure, the plastic floats protected from exposure to sun by the solar panels and the racking structure.

2. The floating solar system of claim 1, further comprising:
walkways attached to the racking structure, to enable human or machine traversal of the floating solar system.

3. The floating solar system of claim 1, further comprising:
an automatic panel washer to clean the solar panels.

4. The floating solar system of claim 1, further comprising a mooring system to attach the floating solar system to land, via a plurality of cables.

5. The floating solar system of claim 4, wherein the mooring system comprises a plurality of shaped concrete blocks and a plurality of cables wherein:
each pair of shaped concrete blocks straddles a top of a berm; and
each cable of the mooring system is coupled to a pair of shaped concrete blocks.

6. The floating solar system of claim 5, wherein the shaped concrete blocks comprise k-bars.

7. The floating solar system of claim 5, wherein a cable loops from the floating solar system, through a first shaped concrete block in a first side of a top of the berm, under the top of the berm, and through a second shaped concrete block at a second side of the top of the berm.

8. The floating solar system of claim 1, further comprising:
walkways attached to the racking structure, the walkways providing a path for maintenance and structural support to the structure.

9. The floating solar system of claim 8, further comprising:
a plurality of rails coupled together forming the racking structure;
a plurality of racking couplings coupling two pieces of the plurality of rails to each other, each racking coupling permitting vertical motion between the two pieces of the rail.

10. The floating solar system of claim 9, wherein a racking coupling comprises a short channel, such that spacing between an interior of the racking coupling and the rail provides space for motion.

11. The floating solar system of claim 9, further comprising:
a plurality of hinge bolts to provide vertical motion for the walkways;
wherein the walkway hinge bolts are aligned with the racking couplings.

12. A floating solar system for placement in water comprising:
a plurality of sets, each set including a float, one or more solar panels, a plurality of rails rigidly fastened, the plurality of rails providing a support structure for the solar panels, and the plurality of rails and one or more solar panels protecting the float from exposure to the sun;
a plurality of racking couplings moveably coupling the plurality of sets to each other, such that the sets can move vertically in the water.

13. The floating solar system of claim 12, further comprising:
wherein the plurality of sets make a racking, and the racking is aluminum.

14. The floating solar system of claim 12, further comprising:
walkways attached to the racking structure, to enable human or machine traversal of the floating solar system.

15. The floating solar system of claim 12, further comprising:
an automatic panel washer to clean the solar panels.

16. The floating solar system of claim 1, further comprising a mooring system to attach the floating solar system to land, via a plurality of cables, wherein the mooring system comprises a plurality of shaped concrete blocks and a plurality of cables wherein:
each pair of shaped concrete blocks straddles a top of a berm; and
each cable of the mooring system is coupled to a pair of shaped concrete blocks.

17. The floating solar system of claim 16, wherein a cable loops from the floating solar system, through a first shaped concrete block in a first side of a top of the berm, under the top of the berm, and through a second shaped concrete block at a second side of the top of the berm.

18. The floating solar system of claim 12, wherein a racking coupling comprises a short channel, such that spacing between an interior of the racking coupling and the rail provides space for motion.

19. The floating solar system of claim 18, further comprising:
a plurality of hinge bolts to provide vertical motion for the walkways;
wherein the walkway hinge bolts are aligned with the racking couplings.

20. A floating solar system comprising:
an armature comprising a plurality of aluminum rails coupled in a grid shape, the grid formed of regularly placed east-west and north-south railings, each railing comprising a plurality of rails fastened with racking couplings allowing vertical motion between adjacent rails;
a plurality of walkways coupled to the aluminum rails along the east-west railings, the walkways providing structural support and enabling human or machine traversal of the floating solar system;
a plurality of solar panels fastened on the armature; and
a plurality of plastic floats fastened on a bottom of the armature, the plastic floats protected from degradation by sun by shade from the plurality of solar panels and the aluminum rails.
